(19) United States
(12) Patent Application Publication
(10) Pub. No.: US 2005/0128497 A1
(43) Pub. Date: Jun. 16, 2005

(54) Color image display apparatus, color converter, color-simulating apparatus, and method for the same

(76) Inventors: Tsuyoshi Hirashima, Kasuya-Gun (JP); Jun Ikeda, Fukuoka (JP); Shuichi Ojima, Fukuoka (JP); Ryouta Hata, Iizuka (JP); Shinya Kiuchi, Iizuka (JP)

Correspondence Address: WENDEROTH, LIND & PONACK, L.L.P., 2033 K STREET N. W., SUITE 800, WASHINGTON, DC, 20006-1021, US

(21) Appl. No.: 11/007,178

(22) Filed: Dec. 9, 2004

(30) Foreign Application Priority Data
Dec. 12, 2003 (JP) 2003-414320

(51) Int. Cl. G06F 15/00; G03F 3/10

(52) U.S. Cl. 358/1.9; 358/518

(57) ABSTRACT

Colorimetry values when a display unit displays tone signals R(i), G(i) and B(i) (where a number i is a tone value; 1<i<n) are acquired. The colorimetry values are defined using a device independent color of a CIE-XYZ color space, and are composed of three attributes X (i), Y (i) and Z (i). Calculation based on the three attributes is performed to generate a tone profile, that is, an adjusting condition. Utilizing the tone profile, a tone-adjusting unit adjusts color data. Color temperature is kept flat, color reproducibility in halftone (for example, a skin color of a natural image) and display quality can be improved.

### BACKGROUND OF THE INVENTION

1. Field of the Invention

The present invention relates to an image display apparatus that controls a color tone to improve color reproducibility of a display device, and arts related thereto.

2. Description of the Related Art

A color LCD (liquid crystal display) has been used as a display of an information terminal (e.g. a personal computer). Recently, the color LCD is often used as a monitor that reproduces a source with high quality (e.g. a movie). When the color LCD reproduces the movie, the color LCD should have color reproducibility like a CRT (cathode-ray tube).

The CRT has flat and same tone characteristics for R (Red), G (Green) and B (Blue), and color temperature thereof is also flat, regardless of tone levels. Since the color temperature is flat, the CRT has fine color balance in halftone and is good at reproducing a natural image (e.g. a skin color).

On the contrary, the color LCD has different tone characteristics for R, G and B, one another. In general, the color LCD is not as good at reproducing the natural image as the CRT.

Document 1 (Japanese patent application Laid-Open No. 2001-312254) discloses the following color adjustment method. In order to acquire a characteristic of the color LCD, brightness components (Y) of R, G, and B are measured by a brightness meter, and so on. The characteristic is inverse-transformed to generate an adjustment characteristic. Utilizing the adjustment characteristic, the characteristic of the color LCD is adjusted, that is, compensation of the characteristic of the color LCD is performed. Furthermore, the adjustment characteristic is preferable stored as an LUT (look-up table) defining an ICC (International Color Consortium) profile.

With respect to the ICC profile, document 1 teaches as follows: Gamma curves of R and G should be mostly equal to each other; and values of gamma curve of B should be greater than those of gamma curves of R and G.

FIG. 13 is a block diagram of a conventional color image display apparatus. As shown in FIG. 13, the conventional color image display apparatus comprises a display unit 1, such as an LCD. Inputted color data defined by utilizing a device dependent color (Herein, a color of an RGB color space) is adjusted by a tone-adjusting unit 3, and the adjusted inputted color data is fed into the display unit 1. The tone-adjusting unit 3 performs an adjustment utilizing a tone profile look-up table stored in a tone profile-storing unit 2.

As shown in FIG. 13, according to the conventional color image display apparatus, which performs a tone adjustment, light outputted from the display unit 1 is measured by a spectrophotometer 4, and a tone profile is determined based on only brightness components (Y) of a CIE-XYZ colorimetric system.

However, the brightness components (Y) are proportional to neither values of tone characteristics R, G and B nor values of luminescence intensity of R, G and B. That is because optical transmission properties of an LCD depend upon wavelength. In other words, when certain voltage is applied onto the LCD, light with short wavelength transmits more halftone light than light with long wavelength. Furthermore, when the voltage applied onto the LCD increases, a transmission property of the light with short wavelength gets saturated prior to that of the light with long wavelength.

As shown in FIG. 14 (horizontal axis: wavelength; vertical axis: weight), brightness components (Y) have a maximum value at a point of 555 (nm), according to human vision characteristics. The brightness components (Y) are defined by utilizing integrated values of weight functions, which are called color matching functions whose weight decreases from the maximum value when wavelength shifts from the point in a positive/negative direction along the horizontal axis.

According to the above-mentioned method, luminescence intensity characteristics of Blue light with short wavelength and Red light with long wavelength are determined based on only the brightness components (Y). Therefore, errors from actual characteristic must become large.

FIG. 15 illustrates a result that inventors of the present invention have studied. In FIG. 15, a horizontal axis thereof indicates signal level (a gray-scaled input signals), and a vertical axis thereof indicates color temperature (K: Kelvin).

An ideal characteristic is a characteristic whose color temperature=6000 K, regardless of signal levels. However, in the LCD, as shown by a bare characteristic (A), when signal level becomes small, color temperature remarkably climbs.

The inventors of the present invention have adjusted color data based on only brightness components, and have got the following result. That is, as shown by a characteristic after adjustment (B), although a slight improvement from the bare characteristic (A) is attained, color temperature still climbs considerably.

Consequently, when the above-mentioned adjustment has completed, fine color balance in halftone cannot be obtained, and color reproducibility like a CRT cannot be realized.

According to the technique of document 1, a tone-adjusting operator should be skillful, and it is difficult to stably adjust characteristics of various LCDs. Furthermore, since tones of Red and Green are made almost same, color temperature tends to climb in halftone.

### OBJECTS AND SUMMARY OF THE INVENTION

In view of the above, an object of the present invention is to provide an image display apparatus that makes color temperature in halftone stable and that earns fine color reproducibility, and arts related thereto.

A first aspect of the present invention provides a color image display apparatus, comprising: a tone-adjusting unit operable to adjust a tone of inputted color data defined by utilizing a device dependent color to generate corrected color data defined by utilizing the device dependent color; a display unit operable to display an image according to the corrected color data; a tone profile-storing unit operable to store a tone profile of the display unit; and a tone profile-generating unit operable to generate the tone profile stored in the tone profile-storing unit, based on at least three attributes of colorimetry values of the display unit the colorimetry values being defined by utilizing a device independent color.

With this structure, the tone profile-generating unit performs calculation based on at least three attributes of colorimetry values of the display unit, and generates the tone profile stored in the tone profile-storing unit. Even when transmission properties of the display unit (e.g. an LCD) change in accordance with wavelength of light, it is easy to make tones of R, G and B of the display unit flat, while preventing color temperature in halftone from increasing. Therefore, color reproducibility of the display unit can be improved when the display unit displays a natural image, and so on. Since the tone profile is uniquely determined according to characteristics of the display unit, an operator of the color image display apparatus need not be skillful.

A second aspect of the present invention provides a color image display apparatus as defined in the first aspect of the present invention, wherein the tone profile-generating unit comprises: a matrix coefficient-generating unit operable to generate matrix coefficients mapping colorimetry values into inputted color data defined by utilizing the device independent color, the colorimetry values being obtained when the display unit displays primary colors of the device independent color, White of the device independent color and Black of the device independent color; and a matrix-operating unit operable to multiply colorimetry values corresponding to the primary colors of the device dependent color and the matrix coefficients generated by the matrix coefficient-generating unit to generate products, thereby the matrix-operating unit outputting the products as a tone profile of the primary colors of the device dependent color.

With this structure, the tone profile can be strictly and precisely expressed utilizing the matrix coefficients.

A third aspect of the present invention provides a color image display apparatus as defined in the first aspect of the present invention, wherein the tone profile-generating unit comprises: a subtraction unit operable to subtract colorimetry values when the display unit displays Black of the device independent color from colorimetry values when the display unit displays the primary colors of the device independent color, to output differences thereof; a matrix coefficient-generating unit operable to generate, based on the differences outputted from the subtraction unit, matrix coefficients mapping colorimetry values into inputted color data defined by utilizing a device dependent color; and a matrix-operating unit operable to multiply the differences outputted from the subtraction unit and the matrix coefficients generated by the matrix coefficient-generating unit to generate products, thereby the matrix-operating unit outputting the products as a tone profile of the primary colors of the device dependent color.

Since the subtraction unit is provided, effect of back light leakage and/or surface-reflected light is excluded, and rise of color temperature is controlled even in regions that the color temperature tends to climb, which are near to Black at low signal level.

A fourth aspect of the present invention provides a color image display apparatus as defined in the first aspect of the present invention, wherein the tone profile-generating unit comprises: a subtraction unit operable to subtract colorimetry values when the display unit displays Black of the device independent color from colorimetry values when the display unit displays the primary colors of the device independent color, to output differences thereof; and a normalization unit operable to normalize the differences outputted by the subtraction unit to generate normalized differences, thereby the normalization unit outputting the normalized differences as a tone profile of the primary colors.

With this structure, since the normalization unit is provided, the tone profile can be generated without the matrix coefficients. Accordingly, the tone adjustment is performed by simpler processes whose calculation amount is less than the prior art.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram of an image display apparatus in an embodiment 1 of the present invention;

FIG. 2 is a block diagram of a tone profile-generating unit in the embodiment 1 of the present invention;

FIG. 3 is a graph showing an example of the tone profile-generating unit in the embodiment 1 of the present invention;

FIG. 4(a) is a graph showing a target gamma characteristic in the embodiment 1 of the present invention;

FIG. 4(b) is a graph showing a function f of a tone-adjusting unit in the embodiment 1 of the present invention;

FIG. 5 is a graph showing a relationship between signal levels and color temperature in the embodiment 1 of the present invention;

FIG. 6 is a block diagram of a tone profile-generating unit in an embodiment 2 of the present invention;

FIG. 7 is a graph showing a relationship between signal levels and color temperature in the embodiment 2 of the present invention;

FIG. 8 is a block diagram of a tone profile-generating unit in an embodiment 3 of the present invention;

FIG. 9 is a block diagram of a color converter in an embodiment 4 of the present invention;

FIG. 10 is a block diagram of a color converter in an embodiment 5 of the present invention;

FIG. 11 is a block diagram of an image display apparatus in an embodiment 6 of the present invention;

FIG. 12 is an explanatory drawing illustrating an evaluation function-generating method;

FIG. 13 is a block diagram of a conventional image display apparatus;

FIG. 14 is an explanatory drawing of color matching functions; and

FIG. 15 is a graph showing a relationship between signal levels and color temperature of the conventional image display apparatus.

### DETAILED DESCRIPTION OF THE PREFERRED EMBODIMENTS

Referring to the drawings, embodiments of the present invention is explained.

### Embodiment 1

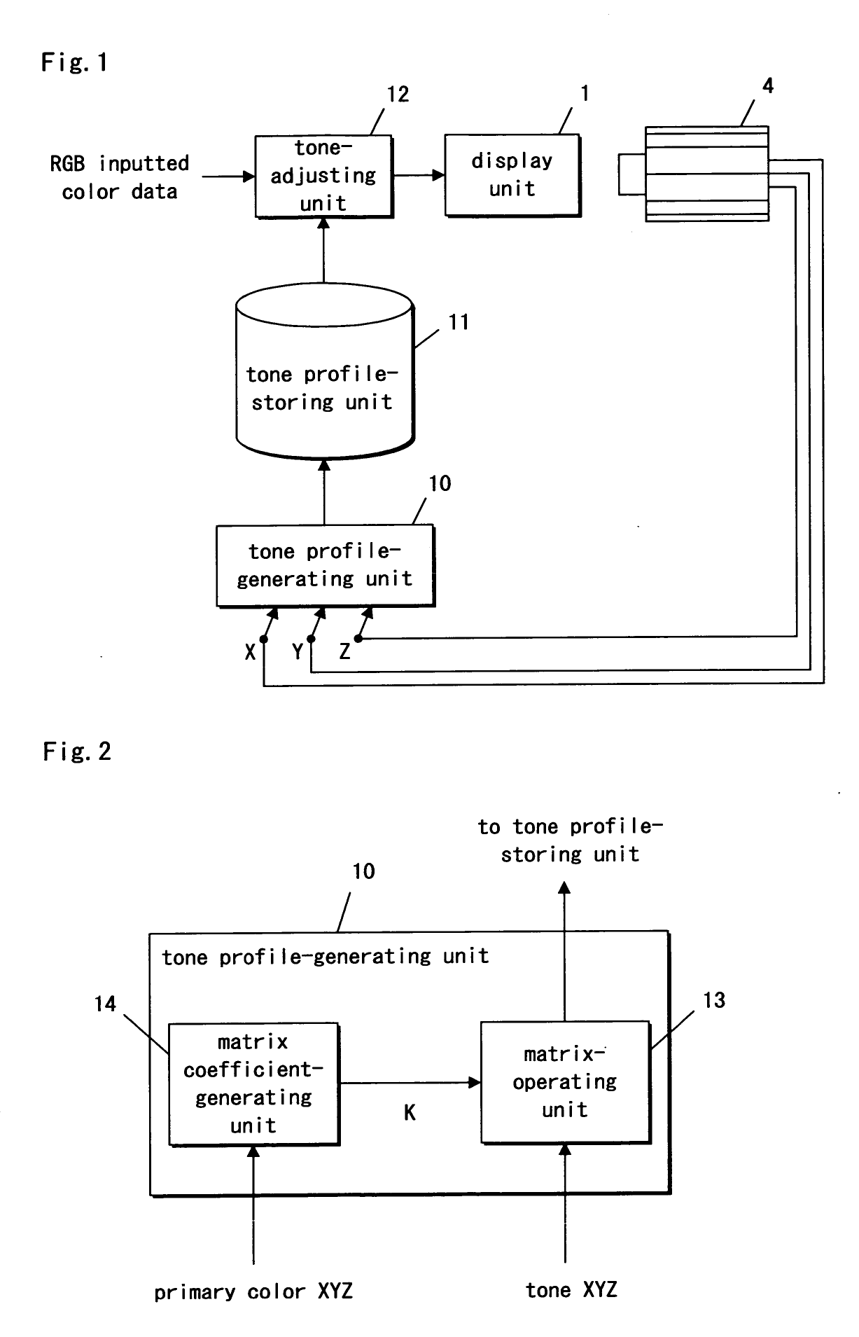

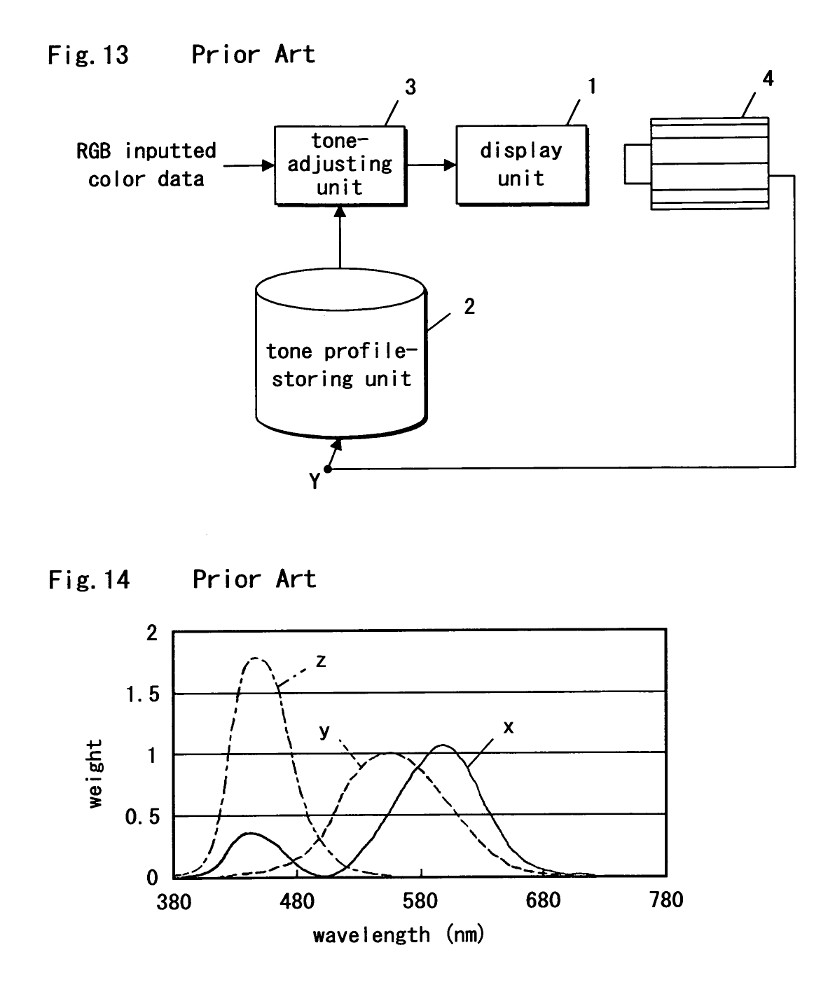

FIG. 1 is a block diagram of an image display apparatus in an embodiment 1 of the present invention. In FIG. 1, in order to avoid duplicated explanation, same symbols are given to same elements as those of FIG. 13.

An image display apparatus of this embodiment performs a tone adjustment of inputted color data of a color image. The inputted color data is defined by utilizing a device dependent color. Stated simply, the image display apparatus performs an inverse transformation (adjustment) of a tone characteristic of a display unit 1, while keeping color balance of the inputted color data.

As shown in FIG. 1, this image display apparatus comprises the following elements. A tone-adjusting unit 12 adjusts a tone of an inputted color data of a color image utilizing a tone profile stored in a tone profile-storing unit 11. The display unit 1 is an LCD that displays color data tone-adjusted by the tone-adjusting unit 12.

A tone profile-generating unit 10 outputs un-adjusted signals to the display unit 1, and performs calculation based on colorimetry values, which indicate device independent CIE-XYZ colors and are measured by a spectrocolorimetry 4. Thereby, the tone profile-generating unit 10 generates a tone characteristic of the display unit 1 as a tone profile. A tone profile-storing unit 11 stores the generated tone profile, and outputs the tone profile to the tone-adjusting unit 12.

As shown in FIG. 2, the tone profile-generating unit 10 comprises the following elements. A matrix coefficient-generating unit 14 solves simultaneous equations based on colorimetry values (CIE-XYZ) of White and three primary colors of Red, Green and Blue to output matrix coefficients K (kij). The colorimetry values are measured when the display unit 1 displays White and the three primary colors.

A matrix-operating unit 13 multiplies colorimetry values of X (i), Y (i) and Z (i) (i: a natural number, 1<i<n, n: a maximum tone number) and the matrix coefficients K to output a result thereof as a tone profile. The colorimetry values of X (i), Y (i) and Z (i) correspond to tone signals R(i), G(i) and B(i) for Red, Green and Blue.

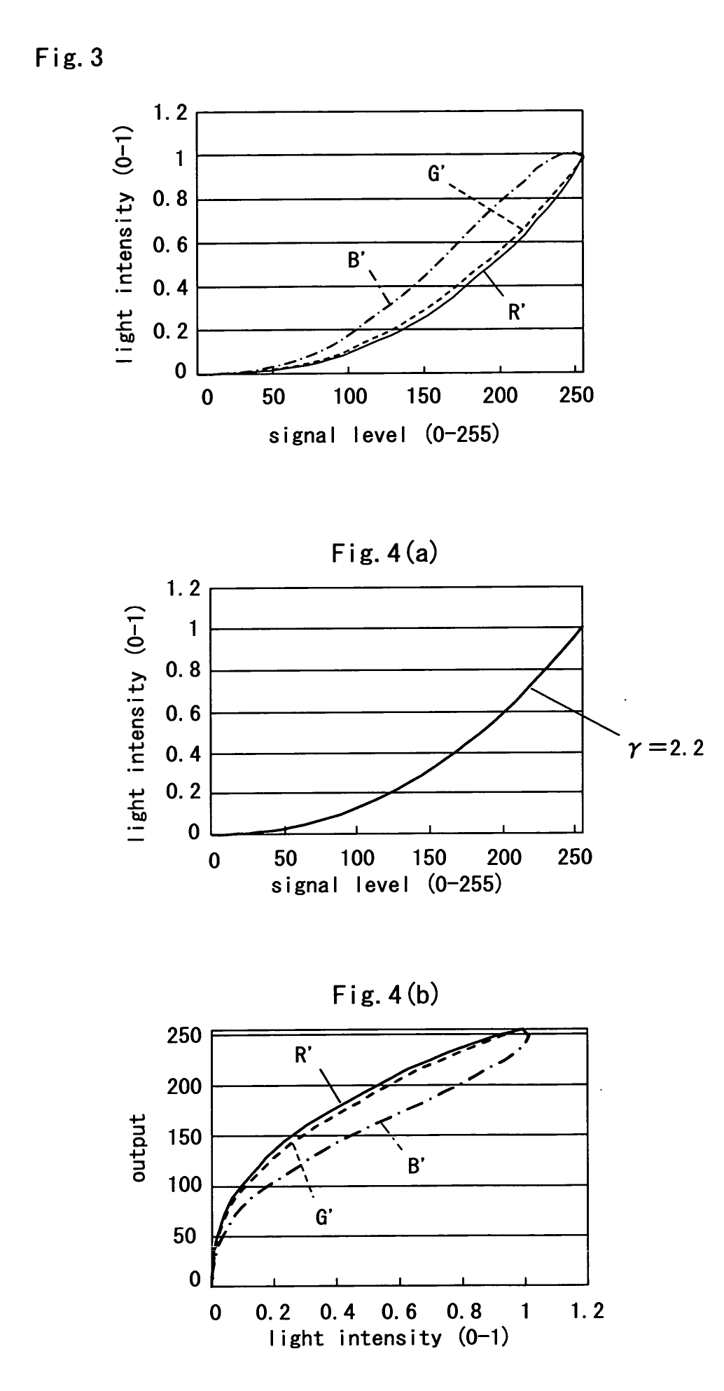

As shown in FIG. 3, a “tone profile” of the present invention expresses the relationship between levels (herein, being normalized to 0-255) of signals of R, G and B and luminescence intensity (herein, being normalized to 0-1) of light emitted by the display unit 1. The tone profile expresses a tone characteristic of the display unit 1 itself.

The adjusting unit 12 adjusts the inputted color data of the color image such that each of tones of R, G and B emitted by the display unit 1 is flat and has the same gamma curve as that of a CRT. According to the following formula, the input color is gamma-adjusted into a target gamma curve as shown in FIG. 4(a).

$$( \begin{matrix}\begin{matrix}{R}_{Linear} \\ {G}_{Linear}\end{matrix} \\ {B}_{Linear}\end{matrix} ) = ( \begin{matrix}\begin{matrix}{( R / 255 )}^{2.2} \\ {( G / 255 )}^{2.2}\end{matrix} \\ {( B / 255 )}^{2.2}\end{matrix} ) \qquad [ Formula 1 ]$$

In this embodiment, it is determined that a target gamma value is a value of 2.2. This is because many CRTs have the gamma value of 2.2.

Next, the tone-adjusting unit 12 converts the gamma-adjusted data utilizing a function f expressed by a graph of FIG. 4(b), and outputs a result thereof.

$$( \begin{matrix}\begin{matrix}{R}^{′} \\ {G}^{′}\end{matrix} \\ {B}^{′}\end{matrix} ) = ( \begin{matrix}\begin{matrix}{f}_{r} ( {R}_{Linear} ) \\ {f}_{g} ( {G}_{Linear} )\end{matrix} \\ {f}_{b} ( {B}_{Linear} )\end{matrix} ) \qquad [ Formula 2 ]$$

The graph of FIG. 4(b) is what input of the tone profile of FIG. 3 and output of the tone profile of FIG. 3 are replaced with each other. That is, the tone-adjusting unit 12 performs an inverse transformation of the tone characteristic of the display unit 1 itself, thereby making each of tones of R, G and B flat. Since the tone profile is practically composed of discrete values, the function f is evaluated utilizing one of polynomial approximation and interpolation calculation with a look-up table defining the tone profile. This tone profile is significant for adjusting colors.

Next, operation of the tone profile-generating unit 10 will now be explained in detail. The display unit 1 inputs un-adjusted tone signals (0-255) of R, G and B, White, and three primary colors of Red, Green and Blue. The spectrocolorimetry 4 measures light emitted by the display unit 1 and output colorimetry values to the tone profile-generating unit 10.

A matrix coefficient-generating unit 14 solves simultaneous equations on condition of the colorimetry values (CIE-XYZ) of White and the three primary colors of Red, Green and Blue. According to the following formula, the matrix coefficient-generating unit 14 outputs a matrix K (kij) that maps signals of Rₗᵢₙₑₐᵣ, Gₗᵢₙₑₐᵣ and Bₗᵢₙₑₐᵣ into CIE-XYZ values one by one. Herein, each of the signals of Rₗᵢₙₑₐᵣ, Gₗᵢₙₑₐᵣ and Bₗᵢₙₑₐᵣ is normalized from “0” to “1”.

$$( \begin{matrix}\begin{matrix}{R}_{Linear} \\ {G}_{Linear}\end{matrix} \\ {B}_{Linear}\end{matrix} ) = ( \begin{matrix}{k}_{11} & {k}_{12} & {k}_{13} \\ {k}_{21} & {k}_{22} & {k}_{23} \\ {k}_{31} & {k}_{32} & {k}_{33}\end{matrix} ) ( \begin{matrix}\begin{matrix}X \\ Y\end{matrix} \\ Z\end{matrix} ) \qquad [ Formula 3 ]$$

Assume that colorimetry values (Xr (i), Yr (i), Zr (i)) correspond to the inputted R tone signals, colorimetry values (Xg (i), Yg (i), Zg (i)) correspond to the inputted G tone signals, and colorimetry values (Xb (i), Yb (i), Zb (i)) correspond to the inputted B tone signals, respectively. The matrix-operating unit 13 performs calculation in accordance with the formulas 4 to 6, and outputs a tone profile. Where, 1<i<n; n is a natural number of tone data. That is, the output of a set of the formulas 4 to 6 corresponds to light intensity of FIG. 3.
R_{Linear}(i)=k₁₁×Xᵣ(i)+k₁₂×Yᵣ(i)+k₁₃×Zᵣ(i) [Formula 4]
G_{Linear}(i)=k₂₁×X_{g}(i)+k₂₂×Y_{g}(i)+k₂₃Z_{g}(i) [Formula 5]
B_{Linear}(i)=k₃₁×X_{b}(i)+k₃₂×Y_{b}(i)+k₃₃×Z_{b}(i) [Formula 6]

The prior art calculates light intensity based on only brightness components Y On the contrary, in this embodiment, not only components Y but also components X and Z are included in condition. Furthermore, weight for light intensity in a CIE-XYZ color space, that is, a contribution rate for the light intensity is evaluated with the mapping function of the formula 3 determined based on the three primary color characteristics of the display unit 1. Color matching functions of FIG. 14 enable calculation based on human vision characteristics converged from wide wavelength regions of light.

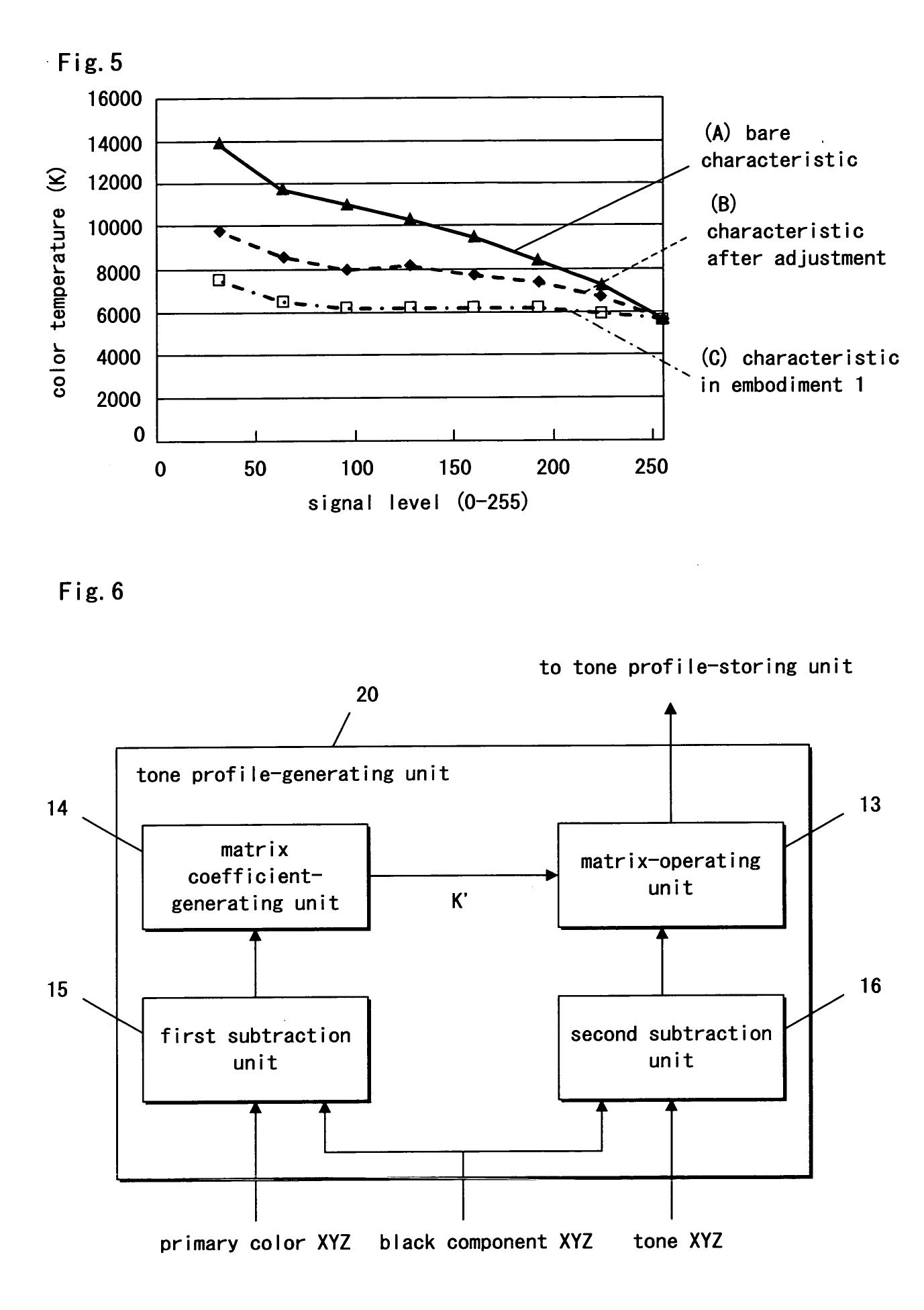

FIG. 5 shows an example in a case where the image display apparatus inputs gray-scaled data and outputted light thereof is measured. Characteristics (c) of the embodiment 1 are almost fixed at color temperature of 6000K. It can be understood that color temperature according to the embodiment 1 is flatter than that of prior art, in which a tone adjustment based on only brightness components (Y) is performed.

The embodiment 1 earns the following effects.

(Effect1) According to a tone adjustment utilizing only brightness components (Y), it is difficult to make tones of R, G and B flat in a device whose transmission properties of light change in accordance with wavelength of the light, such as an LCD, and color temperature tends to climb in halftone. According to this embodiment, a tone profile, which is an important parameter for a tone adjustment, is determined based on matrix coefficients in accordance with device characteristics and CIE-XYZ values. Thereby, tones of R, G and B can be made flat. In other words, color temperature can hardly climbs in halftone.

(Effect 2) Since the tones of R, G and B are made flat, color reproducibility of a natural image, such as a skin color, can be improved.

(Effect 3) Since the tone profile is uniquely determined according to characteristics of the display unit, an operator of the color image display apparatus need not be skillful. The operator can stably adjust characteristics of various LCDs.

This embodiment can be changed as follows.

(Point 1) The display unit may be not an LCD but a display whose transmission properties of light change in accordance with wavelength of the light, such as LCD projector, and so on.

(Point 2) The display may be a display device whose transmission properties of light do not change in accordance with wavelength of the light, such as a CRT. According to the embodiment 1, since values of wide range wavelength is reflected to the tone characteristics, noise caused by conversion is reduced in comparison with a case where a tone adjustment according to only brightness components (Y) is performed.

(Point 3) The device dependent color may be a color of a CMY color space, or four or more primary colors may be used.

(Point 4) In a case where a maximum output value of the formulas 4 to 6 is less than one, a few percent error remaining, a minimum output value of them may be normalized into zero and the maximum output value may be normalized into one, respectively.

### Embodiment 2

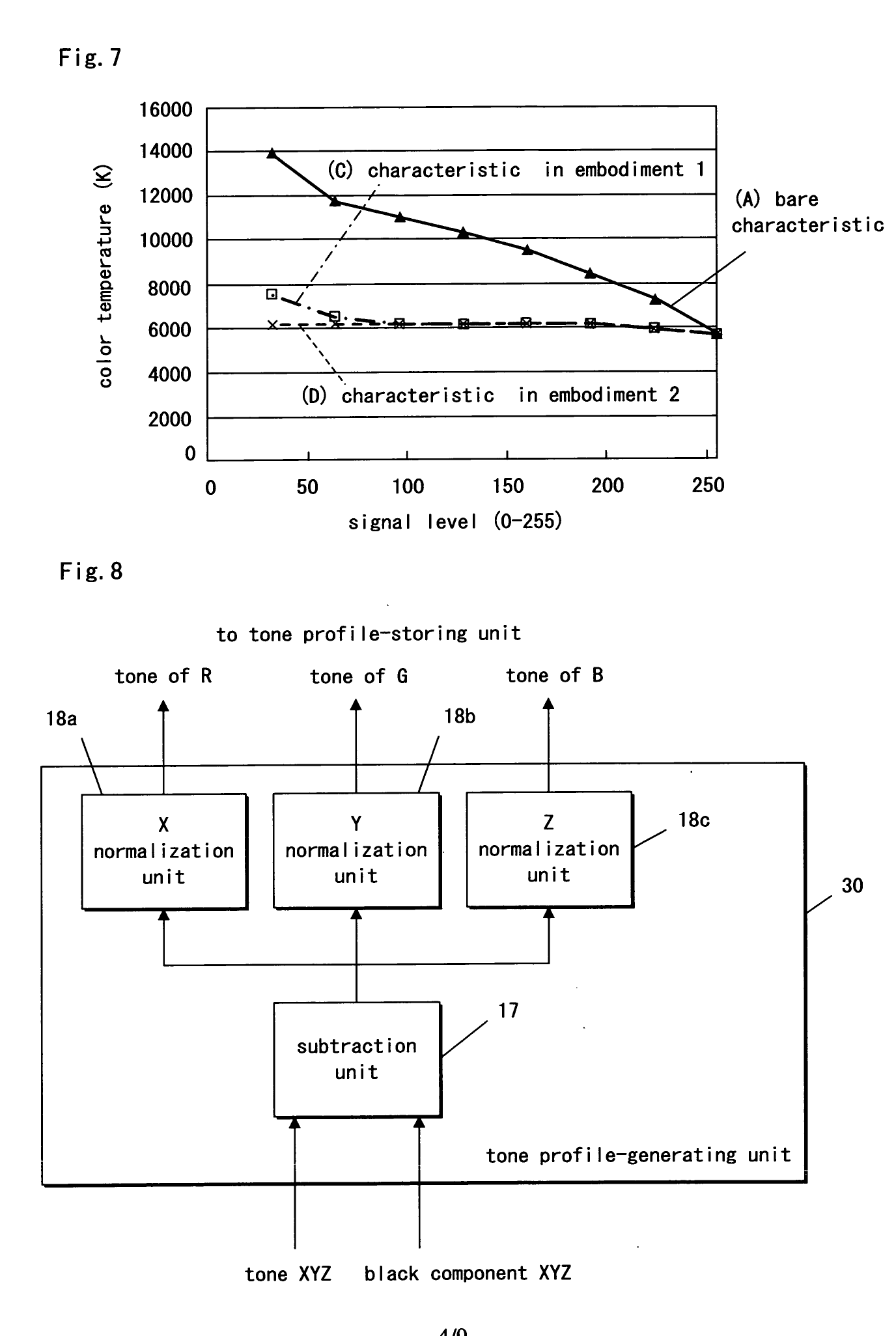

Referring to FIGS. 7 to 6, an embodiment 2 will now be explained. Hereinafter, explanation concerning the same points as the embodiment 1 is omitted.

As shown in FIG. 6, in the embodiment 2 differing from the embodiment 1, a tone profile-generating unit 20 evaluates colorimetry values of Black in addition to the un-adjusted tone signals (0-255) of R, G and B, White, and the three primary colors of Red, Green and Blue. Herein, a “colorimetry value of Black” is a colorimetry value in a case where input signals indicate a value of 0. In an LCD, although the input signals indicate a value of 0, a brightness component (Y) is not generally equal to a value of 0, according to back light leakage when the LCD is transmissive, or surface-reflected light when the LCD is reflective.

FIG. 6 illustrates internal elements of the tone profile-generating unit 20. A first subtraction unit 15 subtracts a colorimetry value of Black from colorimetry values of White and the three primary colors of R, G and B, and outputs a result thereof to the matrix coefficient-generating unit 14. A second subtraction unit 16 subtracts a colorimetry value of Black from colorimetry values of the un-adjusted tone signals (0-255) of R, G and B, and outputs a result thereof to the matrix-operating unit 13.

The matrix coefficient-generating unit 14 and the matrix-operating unit 13 operate in the same manner as the embodiment 1 except that input thereof comes from the subtraction units 15 and 16. A matrix coefficient-generating unit 14 solves simultaneous equations on condition of the difference when the colorimetry value (Xk, Yk, Zk) (CIE-XYZ) of Black is subtracted from each of the colorimetry values (CIE-XYZ) of White and the three primary colors of Red, Green and Blue. According to the following formula, the matrix coefficient-generating unit 14 outputs a matrix K (kij) that maps signals of Rₗᵢₙₑₐᵣ, Gₗᵢₙₑₐᵣ and Bₗᵢₙₑₐᵣ into CIE-XYZ values one by one.

Herein, each of the signals of Rₗᵢₙₑₐᵣ, Gₗᵢₙₑₐᵣ and Bₗᵢₙₑₐᵣ is normalized from “0” to “1”.

$$( \begin{matrix}\begin{matrix}{R}_{Linear} \\ {G}_{Linear}\end{matrix} \\ {B}_{Linear}\end{matrix} ) = ( \begin{matrix}{k}_{11}^{′} & {k}_{12}^{′} & {k}_{13}^{′} \\ {k}_{21}^{′} & {k}_{22}^{′} & {k}_{23}^{′} \\ {k}_{31}^{′} & {k}_{32}^{′} & {k}_{33}^{′}\end{matrix} ) ( \begin{matrix}\begin{matrix}X - {X}_{k} \\ Y - {Y}_{k}\end{matrix} \\ Z - {Z}_{k}\end{matrix} ) \qquad [ Formula 7 ]$$

Assume that colorimetry values (Xᵣ (i), Yᵣ (i), Zᵣ (i)) corresponds to the inputted R tone signals, colorimetry values (X_{g} (i), Y_{g} (i), Z_{g} (i)) corresponds to the inputted G tone signals, and colorimetry values (X_{b} (i), Y_{b} (i), Z_{b} (i)) corresponds to the inputted B tone signals, respectively. The matrix-operating unit 13 performs calculation in accordance with the formulas 4 to 6, and outputs a tone profile. Where, 1<i<n; n is a natural number of tone data.
R_{Linear}(i)=k′₁₁×(Xᵣ(i)−Xₖ)+k′₁₂×(Yᵣ(i)Yₖ)+k′₁₃×(Zᵣ(i)−Zₖ) [Formula 8]
G_{Linear}(i)=k′₂₁×(X_{g}(i)−Xₖ)+k′₂₂×(Y_{g}(i) Yₖ)+k′₂₃×(Z_{g}(i)−Zₖ) [Formula 9]
B_{Linear}(i)=k′₃₁×(X_{b}(i)−Xₖ)+k′₃₂×(Y_{b}(i)−Yₖ)+k′₃₃×(Z_{b}(i)−Zₖ) [Formula 10]

See carefully the characteristics (c) according to the embodiment 1 in FIG. 5. In a region whose signal levels less than a value of 50, color temperature slightly climbs. The reason why is considerable that displayed Black is not perfect Black and a little bluish. Especially in a region whose signal levels are low, luminescence intensity is small. Therefore, minute declination from perfect Black easily causes upturn of color temperature.

In addition to the effects of the embodiment 1, the embodiment 2 earns the following effects.

(Effect 1) In this embodiment, the subtraction units 15 and 16 are additionally provided. Therefore, as shown in FIG. 7, reducing effect of back light leakage of a transmissive LCD and surface-reflected light of a reflective LCD, even in a region whose signal levels are low, color temperature can hardly climbs.

This embodiment can be changed as follows.

(Point 1) The display unit may be not an LCD but a display whose transmission properties of light change in accordance with wavelength of the light, such as an LCD projector, and so on.

(Point 2) The display may be a display device whose transmission properties of light do not change in accordance with wavelength of the light, such as a CRT. According to the embodiment 1, since values of wide range wavelength are reflected to the tone characteristics, noise caused by conversion is reduced in comparison with a case where a tone adjustment according to only brightness components (Y) is performed.

(Point 3) The device dependent color may be a color of a CMY color space, or four or more primary colors may be used.

(Point 4) In a case where a maximum output value of the formulas 4 to 6 is less than one, a few percent error remaining, a minimum output value of them may be normalized into zero and the maximum output value may be normalized into one, respectively.

### Embodiment 3

Referring to FIG. 8, an embodiment 3 will now be explained. Hereinafter, explanation concerning the same points as the embodiment 2 is omitted. In the embodiment 3 differing from the embodiment 2, a tone profile-generating unit 30 evaluates colorimetry values of the un-adjusted tone signals (0-255) of R, G and B and Black. Furthermore, a matrix coefficient-calculating unit is omitted, thereby simplifying operation.

Diagonal components of matrix coefficients of the formula 7 enlarge compared with the other components, when color purity of the display unit 1 becomes high.

The tone profile-generating unit 30 of this embodiment outputs a tone profile utilizing the following simple formulas 11, 12 and 13. An X normalization unit 18a performs calculation according to the formula 11, and outputs a red tone profile. A Y normalization unit 18b performs calculation according to the formula 12, and outputs a green tone profile. A Z normalization unit 18c performs calculation according to the formula 13, and outputs a blue tone profile.
R_{Linear}(i)=(Xᵣ(i)−Xₖ)/(Xᵣ(n)−Xₖ) [Formula 11]
G_{Linear}(i)=(Y_{g}(i)−Yₖ)/(Y_{g}(n)−Yₖ) [Formula 12]
B_{Linear}(i)=(Z_{b}(i)−Zₖ)/(Z_{b}(n)−Zₖ) [Formula 13]

In cases where color purity of the display unit 1 is high or the display unit 1 displays CMY colors, errors caused by tone-generation becomes large. Then, it is preferable to use the methods according to the embodiments 1 and 2.

In addition to the effects of the embodiment 1, the embodiment 3 earns the following effect.

(Effect 1) In this embodiment, since a tone profile is generated utilizing simple operation, the amount of operations can be reduced and it is easy to implement functions according to this embodiment into an apparatus whose system resource is not rich.

### Embodiment 4

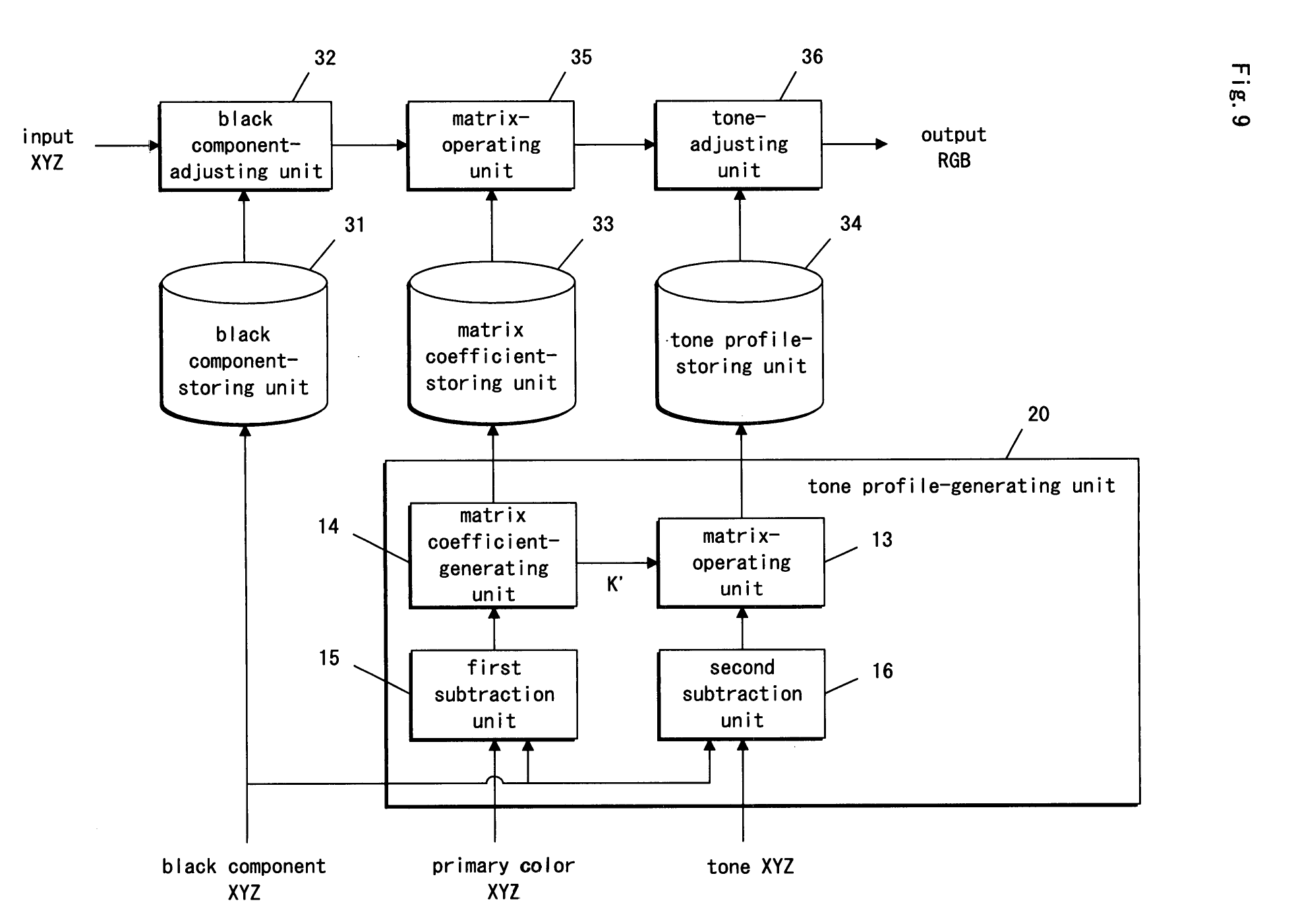

Referring to FIG. 9, an embodiment 4 will now be explained. In order to display an intended color on a certain display device, a color converter of this embodiment converts first color data into second color data. The first color data indicates a device independent color defined in a CIE-XYZ color space. The second color data indicates a device dependent color (R (Red), G (Green) and B (Blue)) of the certain display device.

As shown in FIG. 9, this color converter comprises the following elements. A black component-storing unit 31 stores a colorimetry value of Black of the certain display device. A black component-adjusting unit 32 subtracts the colorimetry value (CIE-XYZ) stored in the black component-storing unit 31 from an input value defined by utilizing a device independent color.

The tone profile-generating unit 20 is the same as that of the embodiment 2. A matrix coefficient-storing unit 33 stores matrix coefficients generated by the matrix coefficient-generating unit 14. A tone profile-storing unit 34 stores a tone profile outputted from the matrix-operating unit 13. A matrix-operating unit 35 converts, utilizing matrix coefficients stored in the matrix coefficient-storing unit 33, output from the black component-adjusting unit 32 into a display device dependent color (herein, RGB color) of the certain display device.

A tone-adjusting unit 36 adjusts, utilizing the tone profile stored in the tone profile-storing unit 34, output from the matrix-operating unit 35 to output device dependent color (herein, RGB color) data of the certain display device.

Next, operation of the color converter of this embodiment will now be explained. According to the following formula, the black component-adjusting unit 32 subtracts a black component (Xₖ, Yₖ, Zₖ) of the certain display device from device independent color data (CIE-XYZ data) to output a result (X′, Y′, Z′).

$$( \begin{matrix}\begin{matrix}{X}^{′} \\ {Y}^{′}\end{matrix} \\ {Z}^{′}\end{matrix} ) = ( \begin{matrix}\begin{matrix}X - {X}_{k} \\ Y - {Y}_{k}\end{matrix} \\ Z - {Z}_{k}\end{matrix} ) \qquad [ Formula 14 ]$$

According to the following formula, the matrix-operating unit 35 converts, utilizing matrix coefficients K stored in the matrix coefficient-storing unit 33, the result (X′, Y′, Z′) outputted from the black component-adjusting unit 32 into RGB light intensity (Rₗᵢₙₑₐᵣ, Gₗᵢₙₑₐᵣ, Bₗᵢₙₑₐᵣ) of the certain display device.

$$( \begin{matrix}\begin{matrix}{R}_{Linear} \\ {G}_{Linear}\end{matrix} \\ {B}_{Linear}\end{matrix} ) = ( \begin{matrix}{k}_{11}^{′} & {k}_{12}^{′} & {k}_{13}^{′} \\ {k}_{21}^{′} & {k}_{22}^{′} & {k}_{23}^{′} \\ {k}_{31}^{′} & {k}_{32}^{′} & {k}_{33}^{′}\end{matrix} ) ( \begin{matrix}\begin{matrix}{X}^{′} \\ {Y}^{′}\end{matrix} \\ {Z}^{′}\end{matrix} ) \qquad [ Formula 15 ]$$

Then, according to the following formula, the tone-adjusting unit 36 converts (adjusts the tone characteristics), utilizing the tone profile stored in the tone profile-storing unit 34, the RGB light intensity (Rₗᵢₙₑₐᵣ, Gₗᵢₙₑₐᵣ, Bₗᵢₙₑₐᵣ) into output (R, G, B) of the color converter.

$$( \begin{matrix}\begin{matrix}R \\ G\end{matrix} \\ B\end{matrix} ) = ( \begin{matrix}\begin{matrix}{f}_{r} ( {R}_{Linear} ) \\ {f}_{g} ( {G}_{Linear} )\end{matrix} \\ {f}_{b} ( {B}_{Linear} )\end{matrix} ) \qquad [ Formula 16 ]$$

The embodiment 4 earns the following effects.

(Effect 1) According to tone adjustment utilizing brightness components (Y), it is difficult to make tones of R, G and B flat in a device whose transmission properties of light change in accordance with wavelength of the light, such as an LCD, and color temperature tends to climb in halftone. According to this embodiment, a tone profile, which is an important parameter for a tone adjustment, is determined based on matrix coefficients in accordance with device characteristics and CIE-XYZ values. Thereby, tones of R, G and B can be made flat. In other words, color temperature can hardly climbs in halftone.

(Effect 2) Since the tones of R, G and B are made flat, color reproducibility of a natural image, such as a skin color, can be improved.

(Effect 3) Since the tone profile is uniquely determined according to characteristics of the display unit, an operator of the color image display apparatus need not be skillful. The operator can stably adjust characteristics of various LCDs.

(Effect 4) Since the black component-adjusting unit 32 is provided, reducing effect of back light leakage of a transmissive LCD and surface-reflected light of a reflective LCD, even in a region whose signal levels are low, color temperature can hardly climbs in halftone.

(Effect 5) Since matrix calculation utilizing matrix coefficients determined on condition with a colorimetry value decreased by the black component is performed, the difference between the intended color and a color actually displayed on the display device can be reduced.

This embodiment can be changed as follows.

(Point 1) The display device is not limited to a specific device and may be a device displaying a color image, like an LCD, a CRT, and so on.

(Point 2) The profile-generating unit, the black component-adjusting unit that actually converts a color image, the matrix-operating unit and the tone-adjusting unit are implemented in one color converter of this embodiment. However, each of them may be implemented in another apparatus.

It is preferable that a color converting system stores a set of device profiles, each of which corresponds to one of various display devices and further each of which includes a set of black components, matrix coefficients and tone profiles. Then, when a display device is connected to the color converting system, what the color converting system should do is only selecting a device profile corresponding to the display device among the set of device profiles to change a current device profile to the selected device profile, without complicated processes, such as measuring various values, and so on.

(Point 3) The device dependent color may be a CMY color.

### Embodiment 5

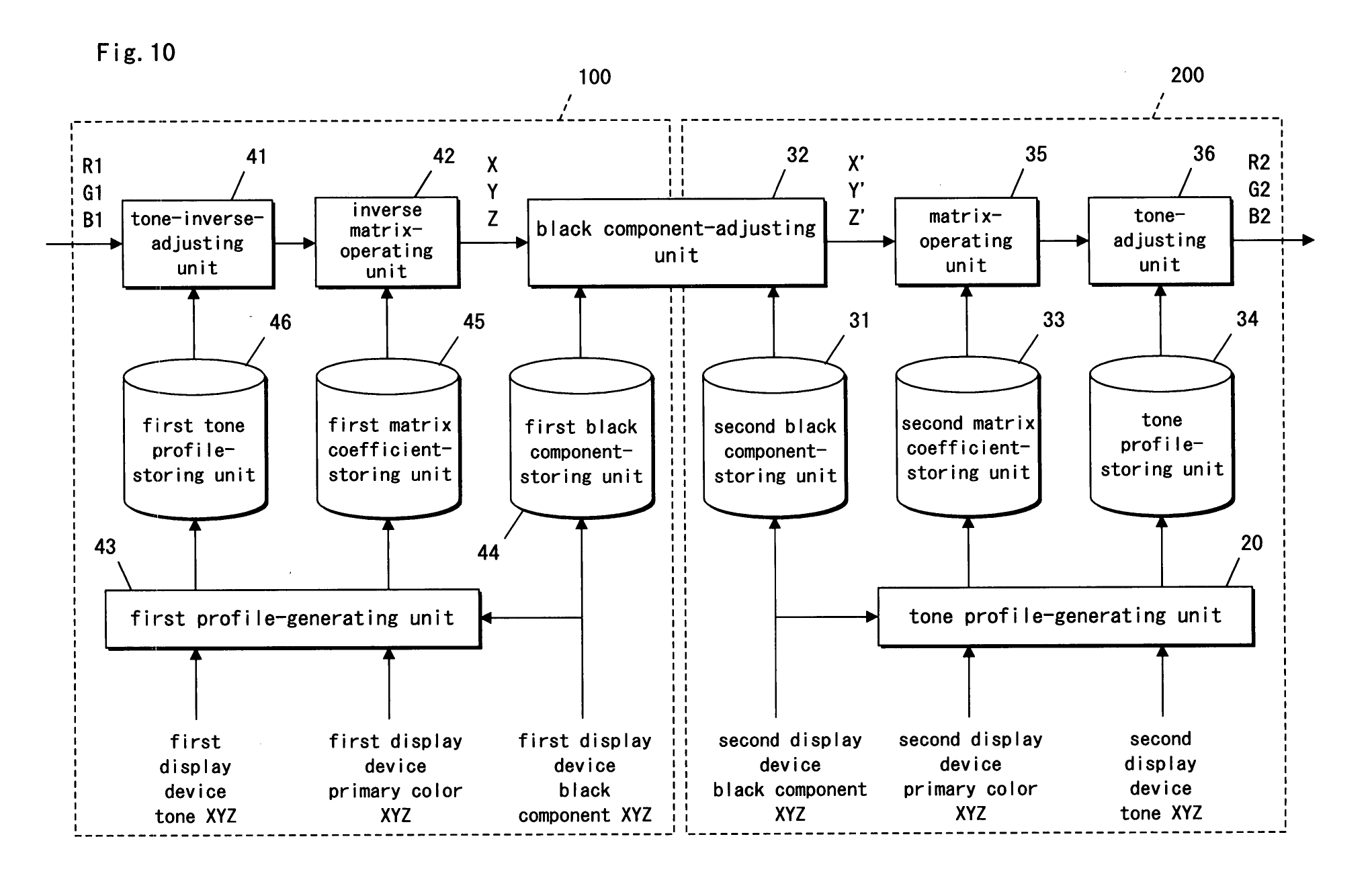

Referring to FIG. 10, an embodiment 5 will now be explained. In order to simulatedly display, on a second display device, a color displayed on a first display device, a color-simulating apparatus converts input color data (R1, G1, B1) for the first display device into input color data (R2, G2, B2) for the second display device. The input color data (R1, G1, B1) for the first display device is defined by utilizing a device dependent color of the first display device. The input color data (R2, G2, B2) for the second display device is defined by utilizing a device dependent color of the second display device.

The color-simulating apparatus can be suitably used in the following situations, for example. The first display device is a development target, which is an LCD of a cellular-phone terminal. The specification, especially a device dependent color, of the LCD is known, however the LCD itself cannot be yet received, because production of the LCD has not been completed. Furthermore, the first display device is an LCD of a computer that a developer uses, and information such as a device dependent color of the second display device is known.

When the developer uses a color-simulating apparatus according to this embodiment, he can evaluate color reproducibility of the first display device, which is an un-received LCD, utilizing his computer and the second display device. Of course, this example does not mean that usage of the color-simulating apparatus of this embodiment is limited to the above-mentioned situations.

As shown in FIG. 10, this color-simulating apparatus can be roughly divided into an input stage 100 and an output stage 200. The input stage 100 converts the device dependent color data (R1, G1, B1) into device independent color (CIE-XYZ) data. The device dependent color data (R1, G1, B1) should be essentially inputted into the first display device, and is defined by utilizing the device dependent color of the first display device.

The output stage 200 converts the device independent color (CIE-XYZ) data into device dependent color data (R2, G2, B2) to output a result thereof to the second display device. The device dependent color data (R2, G2, B2) is defined by utilizing the device dependent color of the second display device. Thereby, a color displayed on the first display device can be simulatedly displayed on the second display device.

A black component-adjusting unit 32 adjusts the device independent color (CIE-XYZ) color data based on the difference between a black component of the first display device and a black component of the second display device to output a result thereof to the output stage 200.

As shown in FIG. 10, the output stage 200 comprises: a matrix-operating unit 35; a tone-adjusting unit 36; a second profile-generating unit 20; a second black component-storing unit 31; a second matrix coefficient-storing unit 33; and a second tone profile-storing unit 34. Since these elements are the same as the matrix-operating unit 35, the tone-adjusting unit 36, the profile-generating unit 20, the black component-storing unit 31, the matrix coefficient-storing unit 33 and the tone profile-storing unit 34 of the embodiment 4, explanation thereof is omitted.

The input stage 100 comprises: a tone-inverse-adjusting unit 41; an inverse matrix-operating unit 42; a first profile-generating unit 43; a first black component-storing unit 44; a first matrix coefficient-storing unit 45; and a first tone profile-storing unit 46.

The tone-inverse-adjusting unit 41 performs an inverse transformation of that of the tone-adjusting unit 36, although operation parameters thereof differ. Similarly, the inverse matrix-operating unit 42 performs an inverse transformation of the matrix-operating unit 35, although operation parameters thereof differ. Each of operation and contents of the first profile-generating unit 43, the first black component-storing unit 44, the first matrix coefficient-storing unit 45, and the first tone profile-storing unit 46 is the same as that of the output stage 200, although the units 43 to 46 input device characteristics of the first display device dissimilar to the output stage 200.

Operation of the color-simulating apparatus of this embodiment will now be explained. The color data (R₁, G₁, B₁), which should be essentially inputted into the first display device and is defined by utilizing the device dependent color of the first display device, is inputted into the input stage 100. According to the following formula, the tone-inverse-adjusting unit 41 adjusts the color data (R₁, G₁, B₁) to output a result thereof as an output value (R₁_{_{—}}ₗᵢₙₑₐᵣ, G₁_{_{—}}ₗᵢₙₑₐᵣ, B₁_{_{—}}ₗᵢₙₑₐᵣ).

$$( \begin{matrix}\begin{matrix}{R}_{1 \_Linear} \\ {G}_{1 \_Linear}\end{matrix} \\ {B}_{1 \_Linear}\end{matrix} ) = ( \begin{matrix}\begin{matrix}{f}_{1 \_r}^{- 1} ( {R}_{1} ) \\ {f}_{1 \_g}^{- 1} ( {G}_{1} )\end{matrix} \\ {f}_{1 \_b}^{- 1} ( {B}_{1} )\end{matrix} ) \qquad [ Formula 17 ]$$

Assume that functions f₁_{_{—}}ᵣ⁻¹, f₁_{_{—}}_{g}⁻¹, and f₁_{_{—}}_{b}⁻¹ are inverse functions determined by the tone profile stored in the first tone profile-storing unit 46. According to the following formula, the inverse-matrix conversion unit 42 converts the output value (R₁_{_{—}}ₗᵢₙₑₐᵣ, G₁_{_{—}}ₗᵢₙₑₐᵣ, B₁_{_{—}}ₗᵢₙₑₐᵣ) into a device independent color (X, Y, Z).

$$( \begin{matrix}\begin{matrix}X \\ Y\end{matrix} \\ Z\end{matrix} ) = {( \begin{matrix}{k}_{1 \_ 11}^{′} & {k}_{1 \_ 12}^{′} & {k}_{1 \_ 13}^{′} \\ {k}_{1 \_ 21}^{′} & {k}_{1 \_ 22}^{′} & {k}_{1 \_ 23}^{′} \\ {k}_{1 \_ 31}^{′} & {k}_{1 \_ 32}^{′} & {k}_{1 \_ 33}^{′}\end{matrix} )}^{- 1} ( \begin{matrix}\begin{matrix}{R}_{1 \_Linear} \\ {G}_{1 \_Linear}\end{matrix} \\ {B}_{1 \_Linear}\end{matrix} ) \qquad [ Formula 18 ]$$

Coefficients K′₁⁻¹ are the first matrix coefficients stored in the first matrix coefficient-storing unit 45. According to the following formula, the black component-adjusting unit 32 adds the device independent color (X, Y, Z) and the black component (X₁_{_{—}}ₖ, Y₁_{_{—}}ₖ, Z₁_{_{—}}ₖ) of the first display device to output a result, and the black component-adjusting unit 32 subtracts the black component (X₂_{_{—}}ₖ, Y₂_{_{—}}ₖ, Z₂_{_{—}}ₖ) of the second display device from the result to output an output value (X′, Y′, Z′) of the output stage 200. The black component (X₁_{_{—}}ₖ, Y₁_{_{—}}ₖ, Z₁_{_{—}}ₖ) is stored in the first black component-storing unit 44, and the black component (X₂_{_{—}}ₖ, Y₂_{_{—}}ₖ, Z₂_{_{—}}ₖ) is stored in the second black component-storing unit 31. The output value (X′, Y′, Z′) is defined by utilizing the device independent color.

$$( \begin{matrix}\begin{matrix}{X}^{′} \\ {Y}^{′}\end{matrix} \\ {Z}^{′}\end{matrix} ) = ( \begin{matrix}\begin{matrix}X + {X}_{1 \_k} - {X}_{2 \_k} \\ Y + {Y}_{1 \_k} - {Y}_{2 \_k}\end{matrix} \\ Z + {Z}_{1 \_k} - {Z}_{2 \_k}\end{matrix} ) \qquad [ Formula 19 ]$$

According to the following formula, the matrix-operating unit 35 converts, utilizing matrix coefficients K′₂ stored in the second matrix coefficient-storing unit 33, the device independent color (X′, Y′, Z′) into RGB light intensity (R₂_{_{—}}_{linear, G}₂_{_{—}}ₗᵢₙₑₐᵣ, B₂_{_{—}}ₗᵢₙₑₐᵣ) of the second display device. The RGB light intensity (R₂_{_{—}}ₗᵢₙₑₐᵣ, G₂_{_{—}}ₗᵢₙₑₐᵣ, B₂_{_{—}}ₗᵢₙₑₐᵣ) relates to the device dependent color of the second display device.

$$( \begin{matrix}{R}_{2 \_Linear} \\ {G}_{2 \_Linear} \\ {B}_{2 \_Linear}\end{matrix} ) = ( \begin{matrix}{k}_{2 \_ 11}^{′} & {k}_{2 \_ 12}^{′} & {k}_{2 \_ 13}^{′} \\ {k}_{2 \_ 21}^{′} & {k}_{2 \_ 22}^{′} & {k}_{2 \_ 23}^{′} \\ {k}_{2 \_ 31}^{′} & {k}_{2 \_ 32}^{′} & {k}_{2 \_ 33}^{′}\end{matrix} ) ( \begin{matrix}{X}^{′} \\ {Y}^{′} \\ {Z}^{′}\end{matrix} ) \qquad [ Formula 20 ]$$

Then, according to the following formula, the tone-adjusting unit 36 adjusts, utilizing the tone profile stored in the tone profile-storing unit 34, tone characteristics of the RGB light intensity (R₂_{_{—}}ₗᵢₙₑₐᵣ, G₂_{_{—}}ₗᵢₙₑₐᵣ, B₂_{_{—}}ₗᵢₙₑₐᵣ), thereby the color-simulating apparatus outputs device dependent color data (R₂, G₂, B₂) of the second display device. The device dependent color data (R₂, G₂, B₂) is defined by utilizing the device dependent color of the second display device.

$$( \begin{matrix}{R}_{2} \\ {G}_{2} \\ {B}_{2}\end{matrix} ) = ( \begin{matrix}{f}_{r} ( {R}_{2 \_Linear} ) \\ {f}_{g} ( {G}_{2 \_Linear} ) \\ {f}_{b} ( {B}_{2 \_Linear} )\end{matrix} ) \qquad [ Formula 21 ]$$

The embodiment 5 earns the following effects.

(Effect 1) According to tone adjustment utilizing brightness components (Y), it is difficult to make tones of R, G and B flat in a device whose transmission properties of light change in accordance with wavelength of the light, such as an LCD, and color temperature tends to climb in halftone. According to this embodiment, a tone profile, which is an important parameter for a tone adjustment, is determined based on matrix coefficients in accordance with device characteristics and CIE-XYZ values. Thereby, tone characteristics of the first display device can be precisely reproduced on the second display device.

(Effect 2) Since the tone profile is uniquely determined according to the tone characteristics, an operator of the color-simulating apparatus need not be skillful. The operator can stably adjust characteristics of various LCDs.

(Effect 3) Since the black component-adjusting unit 32 is provided, effect of back light leakage of a transmissive LCD and surface-reflected light of a reflective LCD can be precisely reproduced.

(Effect 4) Even in a case where a target display device, that is, the first display device cannot be received, if the specification (e.g. a device dependent color) thereof is known, then color reproducibility can be precisely evaluated on another display device, that is, the second display device.

(Effect 5) Since matrix calculation utilizing matrix coefficients determined on condition with a colorimetry value decreased by the black component is performed, the difference between a color actually displayed on the first display device and a color simulatedly displayed on the second display device is reduced.

This embodiment can be changed as follows.

(Point 1) It is sufficient that the display device can display a color image, like an LCD, and a CRT. The display device is not limited to a specific device.

(Point 2) The device dependent color may be a CMY color.

### Embodiment 6

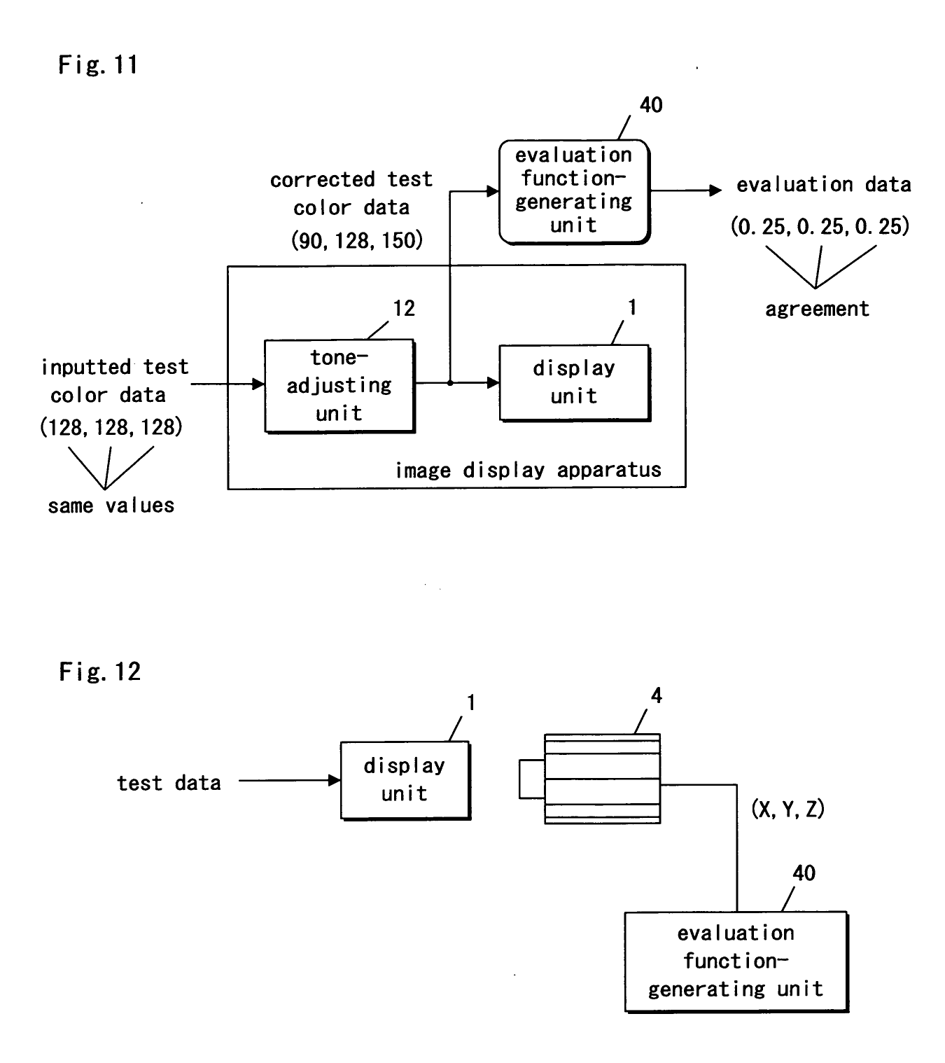

Referring to FIGS. 11 to 12, an image display apparatus according to an embodiment 6 will now be explained. The image display apparatus of this embodiment tone-adjusts inputted color data of a color image to generate adjusted data, and displays the color image according to the adjusted data. The inputted color data is defined by utilizing a device dependent color. Stated simply, the image display apparatus performs an inverse transformation (adjustment) of a tone characteristic of a display unit 1, while keeping color balance of the inputted color data.

As shown in FIG. 11, this image display apparatus comprises the following elements. A tone-adjusting unit 12 adjusts a tone of the inputted color data of the color image. A display unit 1 is an LCD that displays color data tone-adjusted by the tone-adjusting unit 12.

The characteristic of the tone-adjusting unit 12 is determined under the following condition.

(Condition) When color data (test color data), whose component values are equal to each other, is inputted into the tone-adjusting unit 12 as an inputted color data. Output values (adjusted test color data) of the tone-adjusting unit 12 are inputted into an evaluation function-generating unit 40. Output values (estimation data) from the evaluation function-generating unit 40 are equal to each other.

In an example of FIG. 14, test color data (R, G. B)=(128, 128, 128) is inputted into the tone-adjusting unit 12, and the tone-adjusting unit 12 outputs adjusted test color data (R′, G′, B′)=(90, 128, 150) into the evaluation function-generating unit 40. Then, component values of estimation data (RX, GX, BX)=(0.25, 0.25, 0.25) are equal to each other.

Referring to FIG. 12, evaluation functions generated by the evaluation function-generating unit 40 will now be explained. As shown in FIG. 3, an “evaluation function” defines the relationship between levels (herein, being normalized into 0-255) of signals of R, G and B and luminescence intensity (herein, being normalized into 0-1) of light emitted by the display unit 1. In other words, the evaluation function expresses a tone characteristic of the display unit 1 itself.

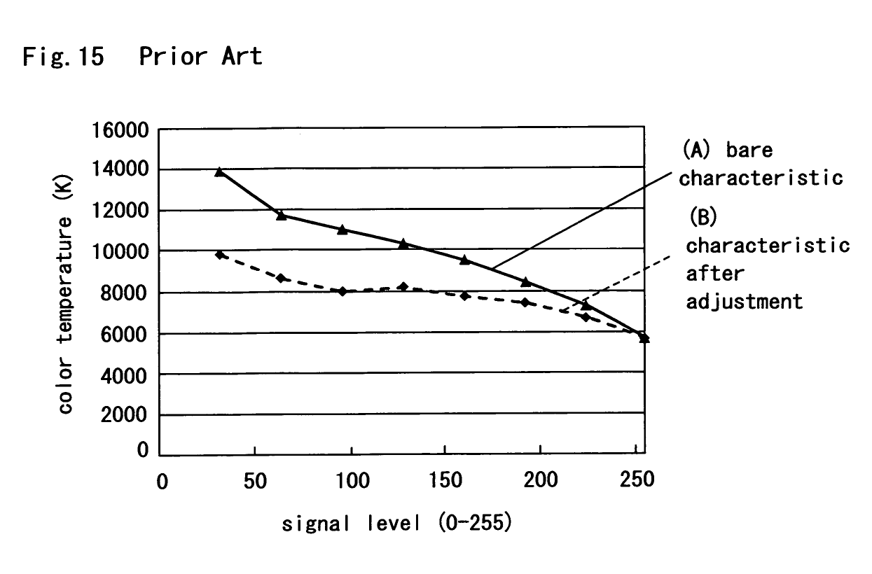

As shown in FIG. 15, un-adjusted signals (0-255) of R, G and B, White, and the three primary colors (Red, Green and Blue) are inputted into the display unit 1. The spectrocolorimetry 4 measures a displayed color to output a result to the evaluation function-generating unit 40.

The evaluation function-generating unit 40 solves simultaneous equations using parameters of the colorimetry values (CIE-XYZ) of White and the three primary colors of Red, Green and Blue. According to the following formula, the evaluation function-generating unit 40 outputs a matrix K (kij) that maps signals of Rₗᵢₙₑₐᵣ, Gₗᵢₙₑₐᵣ and Bₗᵢₙₑₐᵣ into CIE-XYZ values one by one. Herein, each of the signals of Rₗᵢₙₑₐᵣ, Gₗᵢₙₑₐᵣ and Bₗᵢₙₑₐᵣ is normalized from “0” to “1”.

$$( \begin{matrix}{R}_{Linear} \\ {G}_{Linear} \\ {B}_{Linear}\end{matrix} ) = ( \begin{matrix}{k}_{11} & {k}_{12} & {k}_{13} \\ {k}_{21} & {k}_{22} & {k}_{23} \\ {k}_{31} & {k}_{32} & {k}_{33}\end{matrix} ) ( \begin{matrix}X \\ Y \\ Z\end{matrix} ) \qquad [ Formula 22 ]$$

Assume that colorimetry values (Xᵣ (i), Yᵣ (i), Zᵣ (i)) corresponds to the inputted R tone signals, colorimetry values (X_{g} (i), Y_{g} (i), Z_{g} (i)) corresponds to the inputted G tone signals, and colorimetry values (X_{b} (i), Y_{b} (i), Z_{b} (i)) corresponds to the inputted B tone signals, respectively.

The evaluation function-generating unit 40 performs calculation in accordance with the formulas 23 to 25, and determines output values of evaluation functions. Where, 1<i<n; n is a natural number of tone data. That is, the output of a set of the formulas 23 to 25 corresponds to light intensity of FIG. 3 relating to the embodiment 1.
R_{Linear}(i)=k₁₁×Xᵣ(i)+k₁₂×Yᵣ(i)+k₁₃×Zᵣ(i) [Formula 23]
G_{Linear}(i)=k₂₁×X_{g}(i)+k₂₂×Y_{g}(i)+k₂₃×Z_{g}(i) [Formula 24]
B_{Linear}(i)=k₃₁×X_{b}(i)+k₃₂×Y_{b}(i)+k₃₃×Z_{b}(i) [Formula 25]

In comparison with the conventional technique that evaluates tone characteristics based on only brightness components Y, in this embodiment, evaluation is performed utilizing evaluation functions reflecting not only components Y but also components X and Z.

The embodiment 6 earns the following effect.

(Effect 1) According to tone adjustment utilizing brightness components (Y), it is difficult to make tones of R, G and B flat in a device whose transmission properties of light change in accordance with wavelength of the light, such as an LCD, and color temperature tends to climb in halftone.

According to this embodiment, since tone adjustment amount is determined according to evaluation functions, which reflect device characteristics and CIE-XYZ values, tones of R, G and B can be made flat.

According to the present invention, color temperature is stable and a natural image, such as a skin color, can be displayed with high image quality.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A color image display apparatus, comprising:
a tone-adjusting unit operable to adjust a tone of inputted color data defined by utilizing a device dependent color to generate corrected color data defined by utilizing the device dependent color;
a display unit operable to display an image according to the corrected color data;
a tone profile-storing unit operable to store a tone profile of said display unit; and
a tone profile-generating unit operable to generate the tone profile stored in said tone profile-storing unit, based on at least three attributes of colorimetry values of said display unit, the colorimetry values being defined by utilizing a device independent color.

2. The color image display apparatus as claimed in claim 1, wherein said tone profile-generating unit comprises:
a matrix coefficient-generating unit operable to generate matrix coefficients mapping colorimetry values into inputted color data defined by utilizing the device independent color, the colorimetry values being obtained when said display unit displays primary colors of the device independent color, White of the device independent color and Black of the device independent color; and
a matrix-operating unit operable to multiply colorimetry values corresponding to the primary colors of the device dependent color and the matrix coefficients generated by said matrix coefficient-generating unit to generate products, thereby said matrix-operating unit outputting the products as a tone profile of the primary colors of the device dependent color.

3. The color image display apparatus as claimed in claim 1, wherein said tone profile-generating unit comprises:
a subtraction unit operable to subtract colorimetry values when said display unit displays Black of the device independent color from colorimetry values when said display unit displays the primary colors of the device independent color, to output differences thereof;
a matrix coefficient-generating unit operable to generate, based on the differences outputted from said subtraction unit, matrix coefficients mapping colorimetry values into inputted color data defined by utilizing a device dependent color; and
a matrix-operating unit operable to multiply the differences outputted from said subtraction unit and the matrix coefficients generated by said matrix coefficient-generating unit to generate products, thereby said matrix-operating unit outputting the products as a tone profile of the primary colors of the device dependent color.

4. The color image display apparatus as claimed in claim 1, wherein said tone profile-generating unit comprises:
a subtraction unit operable to subtract colorimetry values when said display unit displays Black of the device independent color from colorimetry values when said display unit displays the primary colors of the device independent color, to output differences thereof; and
a normalization unit operable to normalize the differences outputted by said subtraction unit to generate normalized differences, thereby said normalization unit outputting the normalized differences as a tone profile of the primary colors.

5. A color image display apparatus, comprising:
a tone-adjusting unit operable to adjust a tone of inputted color data defined by utilizing a device dependent color to generate corrected color data; and
a display unit operable to display an image according to the corrected color data,
wherein said tone-adjusting unit inputs, as the inputted color data, test color data whose component values equal to each other, thereby outputting corrected test color data,
wherein said tone-adjusting unit inputs the corrected test color data into an evaluation function that performs evaluation based on at least three attributes of colorimetry values of said display unit, thereby outputting evaluated data, and
wherein said tone-adjusting unit adjusts the tone of the inputted color data such that component values of the evaluated data equal to each other.

6. The color image display apparatus as claimed in claim 5, wherein the colorimetry values of said display unit are colorimetry values when said display unit displays the primary colors of the device independent color subtracted by colorimetry values when said display unit displays Black of the device independent color.

7. A color converter operable to convert first color data defined by utilizing a device independent color into second color data defined by utilizing a device dependent color of a display device, the color converter comprising:
a first subtraction unit operable to subtract colorimetry values when the display unit displays Black of the device independent color from the first color data to output first differences;
a second subtraction unit operable to subtract colorimetry values when the display unit displays Black of the device independent color from colorimetry values when the display unit displays primary colors of the device independent color to output second differences;
a matrix coefficient-generating unit operable to generate, based on the second differences, matrix coefficients mapping colorimetry values of the display device into color data defined by utilizing the device dependent color of the display device;
a tone profile-generating unit operable to generate a tone profile based on at least three attributes of colorimetry values of the display device;
a matrix-operating unit operable to multiply the first differences and the matrix coefficients generated by said matrix coefficient-generating unit to generate products; and
a tone-adjusting unit operable to adjust, utilizing the tone profile generated by said tone profile-generating unit, the products generated by said matrix-operating unit to generate the second color data.

8. A color-simulating apparatus operable to simulatedly display a color of a first display device on a second display device, the color-simulating apparatus comprising:
a color-converting unit operable to convert inputted color data into data of a device independent color;
a black component-adjusting unit operable to generate black component-adjusted values, the generate black component-adjusted values being equal to values of the data of the device independent color plus colorimetry values when the first display device displays Black of a device independent color minus colorimetry values when the second display device displays Black of the device independent color;
a subtraction unit operable to subtract colorimetry values when the second display device displays Black of the device independent color from colorimetry values when the second display device displays primary colors of the device independent color to generate differences;
a matrix coefficient-generating unit operable to generate, based on the differences outputted from said subtraction unit, matrix coefficients mapping color data defined by utilizing the device independent color into color data defined by utilizing the device dependent color of the second display device;
a matrix-operating unit operable to convert, utilizing the matrix coefficients generated by said matrix coefficients-generating unit, the black component-adjusted values into data of the device dependent color of the second display device;
a tone profile-generating unit operable to generate a tone profile based on at least three attributes of colorimetry values of the second display device; and
a tone-adjusting unit operable to adjust, utilizing the tone profile generated by said tone profile-generating unit, the data of the device dependent color of the second display device.

9. The color-simulating apparatus as claimed in claim 8, wherein said color-converting unit comprises:
a first tone profile-generating unit operable to generate a first tone profile based on at least three attributes of colorimetry values of the first display device;
a tone-inverse-adjusting unit operable to adjust, utilizing an inverse characteristic of the first tone profile generated by said first tone profile-generating unit, the inputted color data to generate adjusted inputted color data;
a first subtraction unit operable to subtract colorimetry values when the first display device displays Black of the device independent color from colorimetry values when the first display device displays primary colors of the device independent color to generate differences;
a first matrix coefficient-generating unit operable to generate, based on the differences generated by said first subtraction unit, first matrix coefficients mapping a device dependent color of the first display device into the device independent color; and
an inverse-matrix-operating unit operable to convert, utilizing the first matrix coefficients generated by said first matrix coefficient-generating unit, the adjusted inputted color data generated by said tone-inverse-adjusting unit into converted color data, thereby outputting the converted color data as data of a converted device independent color.

10. A color image display method, comprising:
generating a tone profile based on at least three attributes of colorimetry values of a display unit, the colorimetry values being defined by utilizing a device independent color; and
adjusting a tone of inputted color data defined by utilizing a device dependent color to generate corrected color data defined by utilizing the device dependent color.

11. The color image display method as claimed in claim 10, wherein said performing the calculation comprises:
generating matrix coefficients mapping colorimetry values into inputted color data defined by utilizing the device independent color, the colorimetry values being obtained when the display unit displays primary colors of the device independent color, White of the device independent color and Black of the device independent color; and
multiplying colorimetry values corresponding to the primary colors of the device dependent color and the generated matrix coefficients to generate products, thereby outputting the products as a tone profile of the primary colors of the device dependent color.

12. The color image display method as claimed in claim 10, wherein said performing the calculation comprises:
subtracting colorimetry values when the display unit displays Black of the device independent color from colorimetry values when the display unit displays the primary colors of the device independent color, to output differences thereof;
generating, based on the outputted differences, matrix coefficients mapping colorimetry values into inputted color data defined by utilizing a device dependent color; and
multiplying the outputted differences and the generated matrix coefficients to generate products, thereby outputting the products as a tone profile of the primary colors of the device dependent color.

13. The color image display method as claimed in claim 10, wherein said performing the calculation comprises:
subtracting colorimetry values when the display unit displays Black of the device independent color from colorimetry values when the display unit displays the primary colors of the device independent color, to output differences thereof; and
normalizing the outputted differences to generate normalized differences, thereby outputting the normalized differences as a tone profile of the primary colors.

14. A color image display method, comprising:
adjusting a tone of inputted color data defined by utilizing a device dependent color to generate corrected color data; and displaying an image according to the corrected color data,
wherein said tone-adjusting unit inputs, as the inputted color data, test color data whose component values equal to each other, thereby outputting corrected test color data,
wherein said tone-adjusting unit inputs the corrected test color data into an evaluation function that performs evaluation based on at least three attributes of colorimetry values of said display unit, thereby outputting evaluated data, and
wherein said tone-adjusting unit adjusts the tone of the inputted color data such that component values of the evaluated data equal to each other.

15. The color image display method as claimed in claim 14, wherein the colorimetry values of the display unit are colorimetry values when the display unit displays the primary colors of the device independent color subtracted by colorimetry values when the display unit displays Black of the device independent color.

16. A color-converting method for converting first color data defined by utilizing a device independent color into second color data defined by utilizing a device dependent color of a display device, the color-converting method comprising:
subtracting colorimetry values when the display unit displays Black of the device independent color from the first color data to output first differences;
subtracting colorimetry values when the display unit displays Black of the the device independent color from colorimetry values when the display unit displays primary colors of the device independent color to output second differences;
generating, based on the second differences, matrix coefficients mapping colorimetry values of the display device into color data defined by utilizing the device dependent color of the display device;
generating a tone profile based on at least three attributes of colorimetry values of the display device;
multiplying the first differences and the generated matrix coefficients to generate products; and
adjusting, utilizing the generated tone profile, the generated products to generate the second color data.

17. A color-simulating method for simulatedly displaying a color of a first display device on a second display device, the color-simulating method comprising:
converting inputted color data into data of a device independent color;
generating black component-adjusted values, the generate black component-adjusted values being equal to values of the data of the device independent color plus colorimetry values when the first display device displays Black of a device independent color minus colorimetry values when the second display device displays Black of the device independent color;
subtracting colorimetry values when the second display device displays Black of the device independent color from colorimetry values when the second display device displays primary colors of the device independent color to generate differences;
generating, based on the generated differences, matrix coefficients mapping color data defined by utilizing the device independent color into color data defined by utilizing the device dependent color of the second display device;
converting, utilizing the generated matrix coefficients, the black component-adjusted values into data of the device dependent color of the second display device;
generating a tone profile based on at least three attributes of colorimetry values of the second display device; and
adjusting, utilizing the generated tone profile, the data of the device dependent color of the second display device.

18. The color-simulating method as claimed in claim 17, wherein said converting the inputted color data into the data of the device independent color comprises:
generating a first tone profile based on at least three attributes of colorimetry values of the first display device;
adjusting, utilizing an inverse characteristic of the generated first tone profile, the inputted color data to generate adjusted inputted color data;
subtracting colorimetry values when the first display device displays Black of the device independent color from colorimetry values when the first display device displays primary colors of the device independent color to generate differences;
generating, based on the generated differences, first matrix coefficients mapping a device dependent color of the first display device into the device independent color; and
converting, utilizing the generated first matrix coefficients, the adjusted inputted color data into converted color data, thereby outputting the converted color data as data of a converted device independent color.
